(19) United States
(12) Patent Application Publication
(10) Pub. No.: US 2017/0118375 A1
(43) Pub. Date: Apr. 27, 2017

(54) IMAGE FORMING APPARATUS AND INFORMATION PROCESSING APPARATUS

(71) Applicant: Oki Data Corporation, Tokyo (JP)

(72) Inventors: Hideo SUTO, Tokyo (JP); Hideki SATO, Tokyo (JP)

(73) Assignee: Oki Data Corporation, Tokyo (JP)

(21) Appl. No.: 15/297,303

(22) Filed: Oct. 19, 2016

(30) Foreign Application Priority Data
Oct. 26, 2015 (JP) 2015-209541

(51) Int. Cl. H04N 1/32; G03G 15/00

(52) U.S. Cl. CPC H04N 1/32208; H04N 1/32352; H04N 1/32219; G03G 15/50; H04N 2201/0094

(57) ABSTRACT

An image forming apparatus includes a first image forming unit, a second image forming unit, and a generator. The first image forming unit forms a first image on a basis of first image data. The second image forming unit forms a light-emittable second image on a basis of second image data. The generator generates the first image data on a basis of print data, and generates the second image data to cause the second image to be overlaid on part or all of the first image.

### CROSS REFERENCE TO RELATED APPLICATIONS

This application claims the benefit of Japanese Priority Patent Application JP 2015-209541 filed on Oct. 26, 2015, the entire contents of which are incorporated herein by reference.

### BACKGROUND

The invention relates to an image forming apparatus that forms an image, and to an information processing apparatus that supplies print data to the image forming apparatus.

Upon printing contents such as a document, a user may want to so print a so-called watermark that the watermark is overlaid on the contents. The watermark may include a text, a symbol, etc. that indicate a supplier of the contents, for example. Japanese Unexamined Patent Application Publication No. 2009-251847 discloses an image processing apparatus that prints a watermark at a predetermined position, for example.

### SUMMARY

Generally, it may be preferable to achieve high usability of an electronic apparatus for a user. An improvement in usability may be also expected in a field of an image forming apparatus.

It is desirable to provide an image forming apparatus and an information processing apparatus that improve usability for a user.

An image forming apparatus according to one embodiment of the invention includes a first image forming unit, a second image forming unit, and a generator. The first image forming unit forms a first image on a basis of first image data. The second image forming unit forms a light-emittable second image on a basis of second image data. The generator generates the first image data on a basis of print data, and generates the second image data to cause the second image to be overlaid on part or all of the first image.

An image forming apparatus according to one embodiment of the invention includes a first image forming unit, a second image forming unit, and a generator. The first image forming unit forms a first image on a basis of first image data. The second image forming unit forms a light-emittable second image on a basis of second image data. The generator generates the first image data on a basis of print data generated on a basis of data information, and generates the second image data on a basis of additional information of the data information. The additional information accompanies the print data.

An information processing apparatus according to one embodiment of the invention includes a print data generator that generates print data on a basis of data information, and causes additional information of the data information to accompany the print data.

### BRIEF DESCRIPTION OF DRAWINGS

FIG. 1 is a block diagram illustrating a configuration example of an image forming apparatus according to a first example embodiment of the invention.

FIG. 2 is a diagram for explaining a configuration example of a developing unit illustrated in FIG. 1.

FIG. 3 is a block diagram illustrating an example of a control mechanism in the image forming apparatus illustrated in FIG. 1.

FIG. 4 is a configuration diagram illustrating an example of a software configuration in a host PC illustrated in FIG. 3.

FIG. 5 is a table illustrating an operation example of a property information acquiring unit illustrated in FIG. 4.

FIG. 6 is a table illustrating another operation example of the property information acquiring unit illustrated in FIG. 4.

FIG. 7 is a flowchart illustrating an operation example of an image data generator illustrated in FIG. 3.

FIG. 8A is a diagram for explaining an operation example of the image forming apparatus illustrated in FIG. 1.

FIG. 8B is another diagram for explaining the operation example of the image forming apparatus illustrated in FIG. 1.

FIG. 9 is a block diagram illustrating a configuration example of an image forming apparatus according to a second example embodiment.

FIG. 10 is a configuration diagram illustrating an example of a software configuration in a host PC illustrated in FIG. 9.

FIG. 11 is a table illustrating an example of a candidate table illustrated in FIG. 9.

FIG. 12A is a flowchart illustrating an operation example of an image data generator illustrated in FIG. 9.

FIG. 12B is another flowchart illustrating the operation example of the image data generator illustrated in FIG. 9.

FIG. 13 is a diagram for explaining an operation example of an image forming apparatus illustrated in FIG. 9.

FIG. 14 is a diagram for explaining another operation example of the image forming apparatus illustrated in FIG. 9.

FIG. 15 is a diagram for explaining yet another operation example of the image forming apparatus illustrated in FIG. 9.

FIG. 16 is a block diagram illustrating a configuration example of an image forming apparatus according to a modification of the second example embodiment.

### DETAILED DESCRIPTION

Some example embodiments of the invention are described below in detail with reference to the drawings. The description is given in the following order.
1. First Example Embodiment
2. Second Example Embodiment
<1. First Example Embodiment>
[Configuration Example]
(Overall Configuration Example)

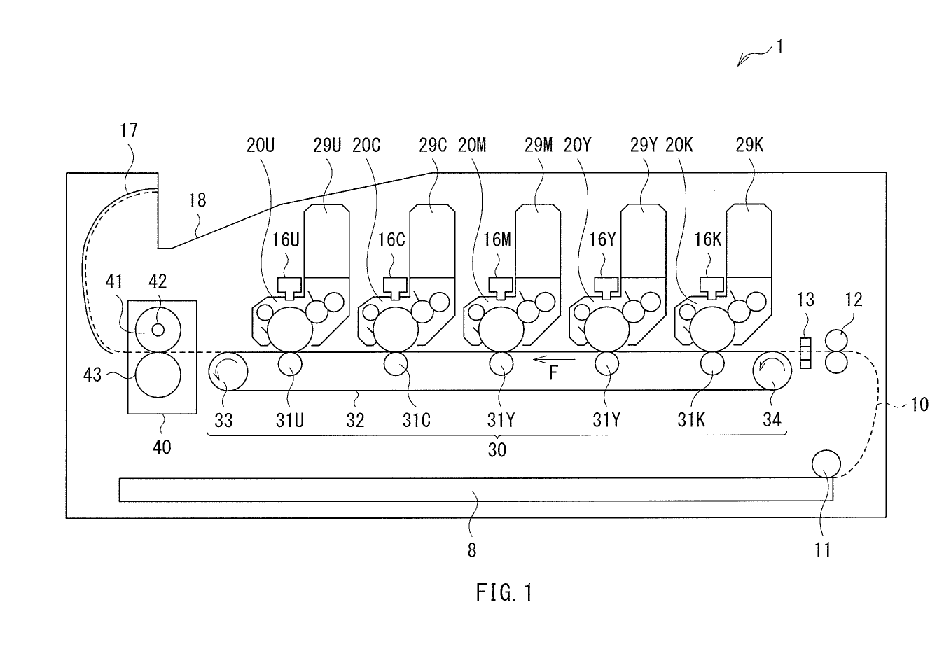

FIG. 1 illustrates a configuration example of an image forming apparatus (an image forming apparatus 1) according to one example embodiment of the invention. The image forming apparatus 1 may serve as a printer that forms an image on a recording medium by an electrophotographic method. The recording medium may be plain paper, for example.

The image forming apparatus 1 may include a hopping roller 11, a resist roller 12, a medium sensor 13, five developing units 20 (20K, 20Y, 20M, 20C, and 20U), five toner containers 29 (29K, 29Y, 29M, 29C, and 29U), five exposure heads 16 (16K, 16Y, 16M, 16C, and 16U), a transferring unit 30, and a fixing unit 40. The foregoing members may be arranged along a conveying path 10 along which a recording medium 9 is to be conveyed.

The hopping roller 11 may be a member that picks up the recording media 9 one by one from the top, and causes the recording medium 9 picked up to travel along the conveying path 10. The recording media 9 may be contained in an attachable and detachable medium cassette 8. The resist roller 12 may be a member including a pair of rollers that sandwich the conveying path 10 in between. The resist roller 12 may align properly the recording medium 9 that has been fed obliquely from the hopping roller 11, and guide the recording medium 9 toward the developing units 20 along the conveying path 10. The medium sensor 13 may detect passing of the recording medium 9.

The developing units 20 may each form a toner image. More specifically, the developing unit 20K may form a black (K) toner image. The developing unit 20Y may form a yellow (Y) toner image. The developing unit 20M may form a magenta (M) toner image. The developing unit 20C may form a cyan (C) toner image. The developing unit 20U may form a toner image using light-emittable toner. The light-emittable toner may be toner that is allowed to emit visible light. The light-emittable toner may be a fluorescent toner, for example. The fluorescent toner may emit visible light due to energy supplied from outside. More specifically, the fluorescent toner may be colorless and transparent in a normal state and may emit light in response to ultraviolet ray application, for example. In the present example embodiment, the respective developing units 20 may be arranged in order of the developing units 20K, 20Y, 20M, 20C, and 20U in a conveying direction F of the recording medium 9. The respective developing units 20 may be attachable and detachable, for example.

The toner container 29K may contain black (K) toner, and be attachable and detachable to the developing unit 20K. Similarly, the toner container 29Y may contain yellow (Y) toner, and be attachable and detachable to the developing unit 20Y. The toner container 29M may contain magenta (M) toner, and be attachable and detachable to the developing unit 20M. The toner container 29C may contain cyan (C) toner, and be attachable and detachable to the developing unit 20C. The toner container 29U may contain light-emittable toner, and be attachable and detachable to the developing unit 20U.

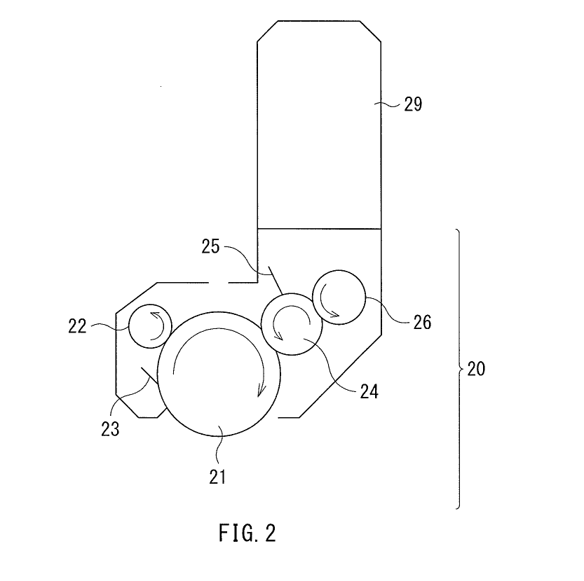

FIG. 2 illustrates a configuration example of the developing unit 20. It is to be noted that FIG. 2 also include illustration of the toner container 29 together with illustration of the developing unit 20. The developing unit 20 may include a photosensitive drum 21, an electrically-charging roller 22, a cleaning blade 23, a developing roller 24, a developing blade 25, and a feeding roller 26.

The photosensitive drum 21 may be a member that has a surface (a surficial part) supporting an electrostatic latent image thereon. The photosensitive drum 21 may include a photoreceptor. The photosensitive drum 21 may be rotated clockwise in the present example embodiment by power transmitted from an unillustrated drum motor. The photosensitive drum 21 may be electrically charged by the electrically-charging roller 22. The photosensitive drum 21 in the developing unit 20K may be exposed by the exposure head 16K. The photosensitive drum 21 in the developing unit 20Y may be exposed by the exposure head 16Y. The photosensitive drum 21 in the developing unit 20M may be exposed by the exposure head 16M. The photosensitive drum 21 in the developing unit 20C may be exposed by the exposure head 16C. The photosensitive drum 21 in the developing unit 20U may be exposed by the exposure head 16U. The electrostatic latent image may be thus formed on the surface of each of the photosensitive drums 21.

The electrically-charging roller 22 may be a member that electrically charges the surface (the surficial part) of the photosensitive drum 21. The electrically-charging roller 22 may be so provided as to be in contact with a surface (a peripheral surface) of the photosensitive drum, and as to be pressed against the photosensitive drum 21 by a predetermined pressing amount. The electrically-charging roller 22 may be rotated counterclockwise in the present example embodiment, in accordance with rotation of the photosensitive drum 21. The electrically-charging roller 22 may receive an electrically-charging voltage from an unillustrated power unit.

The cleaning blade 23 may be a member that scrapes the toner remained on the surface (the surficial part) of the photosensitive drum 21 to clean the surface (the surficial part) of the photosensitive drum 21. The cleaning blade 23 may be so provided as to be in contact with the surface of the photosensitive drum 21 in a counter direction. In other words, the cleaning blade 23 may be so provided as to protrude in a direction opposite to a rotation direction of the photosensitive drum 21. The cleaning blade 23 may be also pressed against the photosensitive drum 21 by a predetermined pressing amount.

The developing roller 24 may be a member having a surface that supports toner thereon. The developing roller 24 may be so provided as to be in contact with the surface (the peripheral surface) of the photosensitive drum 21, and as to be pressed against the photosensitive drum 21 by a predetermined pressing amount. The developing roller 24 may be rotated counterclockwise in the present example embodiment by power transmitted from an unillustrated drum motor. A toner image based on the electrostatic latent image may be formed (developed) on each of the photosensitive drums 21, with the toner fed from each of the developing rollers 24. The developing roller 24 may receive a developing voltage from the unillustrated power unit.

The developing blade 25 may be a member that is in contact with a surface of the developing roller 24, thereby forming a layer made of the toner (a toner layer) on the surface of the developing roller 24 and regulating (controlling or adjusting) thickness of the toner layer to be formed. The developing blade 25 may be a plate-shaped elastic member that is made of a material such as stainless steel and bended to form a shape of the letter “L”, for example. The developing blade 25 may be so provided that the bended part of the developing blade 25 is in contact with the surface of the developing roller 24, and that the developing blade 25 is pressed against the developing roller 24 by a predetermined pressing amount. The developing blade 25 may receive a feed voltage from the unillustrated power unit.

The feeding roller 26 may be a member that feeds the toner stored inside the toner container 29 to the developing roller 24. The feeding roller 26 may be so provided as to be in contact with a surface (a peripheral surface) of the developing roller 24, and as to be pressed against the developing roller 24 by a predetermined pressing amount. The feeding roller 26 may be rotated counterclockwise in the present example embodiment by power transmitted from an unillustrated drum motor. This may generate friction between a surface of the feeding roller 26 and the surface of the developing roller 24 in each of the developing units 20. Accordingly, the toner may be electrically charged due to so-called triboelectric charging in each of the developing units 20. The feeding roller 26 may receive a feed voltage from the unillustrated power unit.

The exposure head 16K illustrated in FIG. 1 may be a member that irradiates the photosensitive drum 21 in the developing unit 20K with light. The exposure head 16Y may be a member that irradiates the photosensitive drum 21 in the developing unit 20Y with light. The exposure head 16M may be a member that irradiates the photosensitive drum 21 in the developing unit 20M with light. The exposure head 16C may be a member that irradiates the photosensitive drum 21 in the developing unit 20C with light. The exposure head 16U may be a member that irradiates the photosensitive drum 21 in the developing unit 20U with light. Accordingly, each of the foregoing photosensitive drums 21 may be exposed by corresponding one of the exposure heads 16K, 16Y, 16M, 16C, and 16U. The electrostatic latent image may be thus formed on the surface of each of the photosensitive drums 21.

The transferring unit 30 may be a member that transfers each of the toner images formed by the five developing units 20K, 20Y, 20M, 20C, and 20U on a targeted surface of the recording medium 9. The transferring unit 30 may include five transferring rollers 31 (31K, 31Y, 31M, 31C, and 31U), a transferring belt 32, a driving roller 33, and a driven roller 34.

The transferring roller 31K may face the photosensitive drum 21 in the developing unit 20K with the conveying path 10 in between. The transferring roller 31Y may face the photosensitive drum 21 in the developing unit 20Y with the conveying path 10 in between. The transferring roller 31M may face the photosensitive drum 21 in the developing unit 20M with the conveying path 10 in between. The transferring roller 31C may face the photosensitive drum 21 in the developing unit 20C with the conveying path 10 in between. The transferring roller 31U may face the photosensitive drum 21 in the developing unit 20U with the conveying path 10 in between. The transferring rollers 31K, 31Y, 31M, 31C, and 31U may each receive a transfer voltage from the unillustrated power unit.

The transferring belt 32 may convey the recording medium 9 along the conveying path 10. The transferring belt 32 may be stretched by the driving roller 33 and the driven roller 34. In other words, the transferring belt 32 may lie from the driving roller 33 to the driven roller 34 while being stretched. The transferring belt 32 may be rotated circularly in the conveying direction F in accordance with rotation of the driving roller 33. Upon rotating in such a manner, the transferring belt 32 may travel between the developing unit 20K and the transferring roller 31K, between the developing unit 20Y and the transferring roller 31Y, between the developing unit 20M and the transferring roller 31M, between the developing unit 20C and the transferring roller 31C, and between the developing unit 20U and the transferring roller 31U.

The driving roller 33 may circularly rotate the transferring belt 32. In the present example embodiment, the driving roller 33 may be provided downstream from the five developing units 20 in the conveying direction F. The driving roller 33 may be rotated counterclockwise in the present example embodiment by power transmitted from an unillustrated belt motor. The driving roller 33 may thus rotate the transferring belt 32 circularly in the conveying direction F.

The driven roller 34 may be rotated counterclockwise in the present example embodiment in accordance with the circular rotation of the transferring belt 32. In the present example embodiment, the driven roller 34 may be provided upstream from the five developing units 20 in the conveying direction F.

The fixing unit 40 may be a member that applies heat and pressure onto the recording medium 9 to thereby fix, on the recording medium 9, the toner image that has been transferred on the recording medium 9. The fixing unit 40 may include a heating roller 41 and a pressurizing roller 43. The heating roller 41 may include inside a heater 42. The heating roller 41 may be a member that applies heat on the toner on the recording medium 9. The heater 42 may be a halogen heater, for example. The pressurizing roller 43 may be so provided as to provide a pressure contact portion between the heating roller 41 and the pressurizing roller 43. The pressurizing roller 43 may be a member that applies pressure on the toner on the recording medium 9. The fixing unit 40 may thus heat, melt, and pressurize the toner on the recording medium 9. As a result, the toner image is fixed on the recording medium 9.

The image forming apparatus 1 may thus perform printing on the recording medium 9. The recording medium 9 that has been subjected to the printing may be conveyed along the conveying path 10 by the medium guide 17 to be placed on a discharge tray 18.

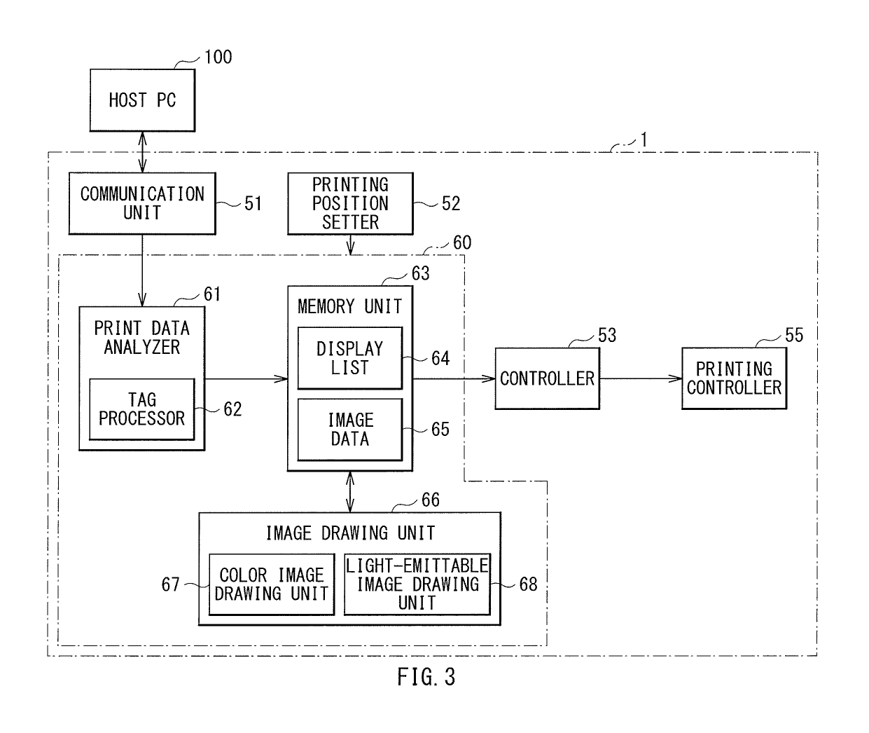

FIG. 3 illustrates an example of a control mechanism in the image forming apparatus 1. The image forming apparatus 1 may operate on the basis of print data DP supplied from a host personal computer (PC) 100. The host PC 100 may include a central processing unit (CPU), a memory, a hard disk drive (HDD), an input unit, a display unit, and a communication unit, for example. The input unit may include components such as a keyboard and a mouse. The display unit may be a display such as a liquid crystal display. The communication unit may be provided to communicate with the image forming apparatus 1.

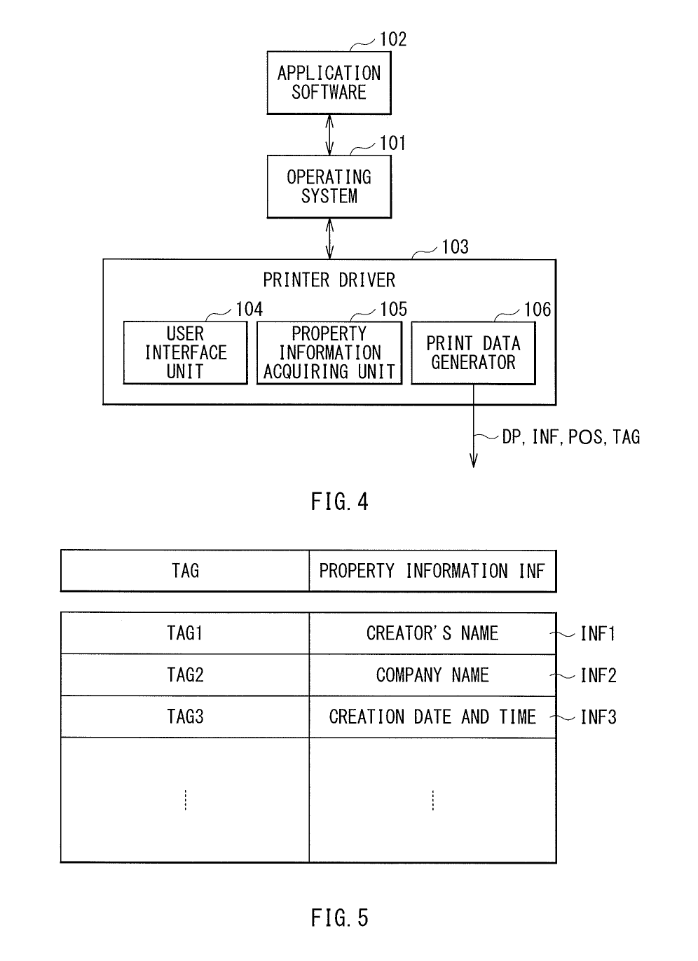

FIG. 4 illustrates an example of a software configuration in the host PC 100 that supplies the print data DP to the image forming apparatus 1. An operating system 101, application software 102, and a printer driver 103 may be installed on the host PC 100.

The operating system 101 may be so-called basic software that controls operation of the host PC 100.

The application software 102 may be software such as word processor software and spreadsheet software, for example. The application software 102 may generate contents data for a color image that is to be printed with the toner of four colors, i.e., black toner, yellow toner, magenta toner, and cyan toner. The color image may include one or more of a picture object P, a graphic object G, and a text object T. The picture object P may be a raster graphics image, and the graphic object G may be a vector graphics image, in the present example embodiment.

The application software 102 may manage the contents data and property information INF of the contents data, using a single electronic file. The property information INF may include information about the name of a creator of the contents, the name of a company to which the creator belongs, the date and the time of creation of the contents, change history of the contents, the expire date of the contents, etc., for example. The property information INF may also include memo information in which a user is allowed to freely write.

The application software 102 may also generate a spooled file on the basis of the contents data in response to an printing instruction from the user. The application software 102 may supply the generated spooled file to the printer driver 103 via the operating system 101.

The printer driver 103 may be a so-called device driver that controls the operation of the image forming apparatus 1. The printer driver 103 may include a user interface unit 104, a property information acquiring unit 105, and a print data generator 106.

The user interface unit 104 may display a printing setting screen on the display unit of the host PC 100. The user interface unit 104 may perform various types of printing setting in response to reception of the instructions from the user.

The property information acquiring unit 105 may acquire the property information INF from the application software 102 via the operating system 101. More specifically, the property information acquiring unit 105 may acquire the property information INF from the application software 102, for example, when the user instructs to print the property information INF on the recording medium 9, using the printing setting screen. Further, the property information acquiring unit 105 may attach a tag TAG to each piece of information to be printed on the recording medium 9 out of the acquired property information INF.

FIG. 5 illustrates an example of the property information INF and the tag TAG. This example illustrates a case in which the property information acquiring unit 105 attaches a tag TAG1 to property information INF1 that indicates the name of the creator of the contents, attaches a tag TAG2 to property information INF2 that indicates the name of the company to which the creator of the contents belongs, and attaches a tag TAG3 to property information INF3 that indicates the date and the time of creation of the contents. The property information acquiring unit 105 may thus attach different tags TAG to the respective pieces of property information INF to be printed.

Further, the property information acquiring unit 105 may generate position information POS that indicates a printing position on the recording medium 9 at which the property information INF is to be printed. More specifically, the property information acquiring unit 105 may generate the position information POS, for example, when the user instructs to set the printing position of the property information INF, using the printing setting screen. Upon generating the position information POS, the property information acquiring unit 105 may allow the user to select, for example, one of positions such as “upper-right of the recording medium 9”, “upper-left of the recording medium 9”, “lower-right of the recording medium 9”, and “lower-left of the recording medium 9”, using the printing setting screen. The property information acquiring unit 105 may generate the position information POS on the basis of a result of the selection. Alternatively, the property information acquiring unit 105 may generate the position information POS on the basis of information such as coordinate information inputted by the user. Further, the property information acquiring unit 105 may attach the tag TAG also to the generated position information POS.

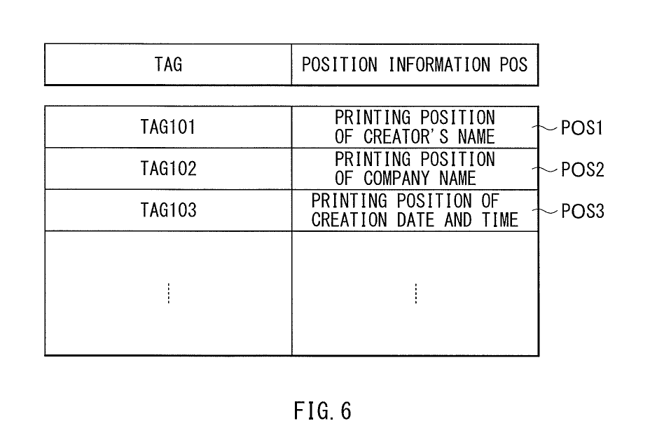

FIG. 6 illustrates an example of the position information POS and the tag TAG. This example illustrates a case in which the property information acquiring unit 105 attaches a tag TAG101 to position information POS1 that indicates a printing position of the name of the creator (the property information INF1), attaches a tag TAG102 to position information POS2 that indicates a printing position of the name of the company (the property information INF2), and attaches a tag TAG103 to position information POS3 that indicates a printing position of the date and the time of creation (the property information INF3). The property information acquiring unit 105 may thus attach different tags TAG to the respective pieces of the position information POS of the property information INF to be printed.

The print data generator 106 may generate the print data DP on the basis of the spooled file. The print data DP may be written in a page description language (PDL) in the present example embodiment, for example. The print data generator 106 may transmit the generated print data DP to the image forming apparatus 1. Upon transmitting the print data DP, the print data generator 106 may transmit, to the image forming apparatus 1, the property information INF acquired by the property information acquiring unit 105 and the position information POS and the tag TAG generated by the property information acquiring unit 105, together with the print data DP.

The image forming apparatus 1 illustrated in FIG. 3 may include a communication unit 51, a printing position setter 52, an image data generator 60, a controller 53, and a printing controller 55.

The communication unit 51 may receive the print data DP, the property information INF, the position information POS, and the tag TAG from the host PC 100 in this example. The communication unit 51 may be coupled to the host PC 100 by means of a universal serial bus (USB) or via local area network (LAN), for example.

The printing position setter 52 may display the printing setting screen on an unillustrated display unit of the image forming apparatus 1, and set the printing position of the property information INF on the recording medium 9 on the basis of the information inputted by the user. More specifically, the printing position setter 52 may allow the user to select, for example, one of positions such as “upper-right of the recording medium 9”, “upper-left of the recording medium 9”, “lower-right of the recording medium 9”, and “lower-left of the recording medium 9”, using the printing setting screen. The printing position setter 52 may set the printing position on the basis of a result of the selection. Alternatively, the printing position setter 52 may set the printing position on the basis of information such as coordinate information inputted by the user.

The image data generator 60 may generate image data 65 on the basis of the print data DP. The image data 65 may include five pieces of image data, i.e., image data 65K, image data 65Y, image data 65M, image data 65C, and image data 65U. The image data 65K may be data of a black image to be formed of the black (K) toner. The image data 65Y may be data of a yellow image to be formed of the yellow (Y) toner. The image data 65M may be data of a magenta image to be formed of the magenta (M) toner. The image data 65C may be data of a cyan image to be formed of the cyan (C) toner. The image data 65U may be data of light-emittable image to be formed of the light-emittable toner. The image data generator 60 may include a print data analyzer 61, an image drawing unit 66, and a memory unit 63.

The print data analyzer 61 may analyze the print data DP to thereby generate an intermediate code for the color image that is to be printed with the toner of four colors, i.e., the black toner, the yellow toner, the magenta toner, and the cyan toner. Upon generating the intermediate code, the print data analyzer 61 may generate an intermediate code for each of the picture object P, the graphic object G, and the text object T.

Further, the print data analyzer 61 may generate an intermediate code for the light-emittable image that is to be printed with the light-emittable toner on the basis of the property information INF. The print data analyzer 61 may include a tag processor 62. The tag processor 62 may acquire the property information INF using the tag TAG. More specifically, the tag processor 62 may recognize information with a predetermined tag TAG as the property information INF. The tag processor 62 may also acquire the position information POS using the tag TAG when the position information POS is also supplied thereto. More specifically, the tag processor 62 may recognize information with a predetermined tag TAG as the position information POS. When the tag processor 62 has acquired the position information POS, the print data analyzer 61 may set the printing position of the property information INF on the basis of the position information POS, to thereby generate the intermediate code for the light-emittable image. Alternatively, when the tag processor 62 has not acquired the position information POS, the print data analyzer 61 may set the printing position of the property information INF on the basis of a setting value set by the printing position setter 52, to thereby generate the intermediate code for the light-emittable image.

The print data analyzer 61 may thus generate the intermediate code for the color image and the intermediate code for the light-emittable image. Further, the print data analyzer 61 may store the generated intermediate codes in the memory unit 63 as a display list 64.

The image drawing unit 66 may generate the image data 65 on the basis of the display list 64 stored in the memory unit 63. The image drawing unit 66 may include a color image drawing unit 67 and a light-emittable image drawing unit 68. The color image drawing unit 67 may generate the image data 65K, the image data 65Y, the image data 65M, and the image data 65C on the basis of the intermediate code for the color image included in the display list 64. The light-emittable image drawing unit 68 may generate the image data 65U on the basis of the intermediate code for the light-emittable image included in the display list 64. Further, the image drawing unit 66 may store, in the memory unit 63, the image data 65K, the image data 65Y, the image data 65M, the image data 65C, and the image data 65U that have been thus generated, as the image data 65.

The memory unit 63 may store the display list 64 and the image data 65.

The controller 53 may control the overall operation of the image forming apparatus 1. The controller 53 may also supply the image data 65 stored in the memory unit 63 to the printing controller 55.

The printing controller 55 may control operation of the respective members such as the five exposure heads 16, the five developing units 20, the transferring unit 30, the fixing unit 40, and the various rollers included in the image forming apparatus 1, on the basis of the image data 65 supplied from the controller 53.

In the present example embodiment, the developing units 20K, 20Y, 20M, and 20C and the exposure heads 16K, 16Y, 16M, and 16C may correspond to a “first image forming unit” in one specific but non-limiting embodiment of the invention. The image data 65K, the image data 65Y, the image data 65M, and the image data 65C may correspond to “first image data” in one specific but non-limiting embodiment of the invention. The developing unit 20U and the exposure head 16U may correspond to a “second image forming unit” in one specific but non-limiting embodiment of the invention. The image data 65U may correspond to “second image data” in one specific but non-limiting embodiment of the invention. The image data generator 60 may correspond to a “generator” in one specific but non-limiting embodiment of the invention. The property information INF may correspond to “additional information” in one specific but non-limiting embodiment of the invention. The printing position setter 52 may correspond to a “position setter” in one specific but non-limiting embodiment of the invention. The property information acquiring unit 105 and the print data generator 106 may correspond to “print data generator” in one specific but non-limiting embodiment of the invention.

### [Operation and Workings]

Next, the operation and workings of the image forming apparatus 1 according to the present example embodiment are described.

### (Outline of Overall Operation)

First, an outline of overall operation of the image forming apparatus 1 is described with reference to FIGS. 1 to 3. The image forming apparatus 1 may have a configuration in which the image data generator 60 illustrated in FIG. 3 receives, for example, the print data DP, the property information INF, the position information POS, and the tag TAG from the host PC 100 via the communication unit 51. The print data analyzer 61 may generate the intermediate code for the color image on the basis of the received print data DP, and also generate the intermediate code for the light-emittable image on the basis of the property information INF, the position information POS, and the tag TAG Further, the image drawing unit 66 may generate the image data 65K, the image data 65Y, the image data 65M, the image data 65C, and the image data 65U on the basis of the generated intermediate codes. The controller 53 may supply the image data 65K, the image data 65Y, the image data 65M, the image data 65C, and the image data 65U that have been generated to the printing controller 55. The printing controller 55 may control the operation of the respective members such as the five developing units 20, the transferring unit 30, and the fixing unit 40 included in the image forming apparatus 1 illustrated in FIG. 1, on the basis of the image data 65 supplied from the controller 53. More specifically, the exposure head 16K and the developing unit 20K may form a toner image of the black toner on the basis of the image data 65K. The exposure head 16Y and the developing unit 20Y may form a toner image of the yellow toner on the basis of the image data 65Y. The exposure head 16M and the developing unit 20M may form a toner image of the magenta toner on the basis of the image data 65M. The exposure head 16C and the developing unit 20C may form a toner image of the cyan toner on the basis of the image data 65C. The exposure head 16U and the developing unit 20U may form a toner image of the light-emittable toner on the basis of the image data 65U. The transferring unit 30 may transfer, onto the recording medium 9, the toner image generated by each of the developing units 20. Further, the fixing unit 40 may fix the toner images on the recording medium 9. The image forming apparatus 1 may thus print the color image and the light-emittable image on the recording medium 9.

### (Detailed Operation of Image Data Generator 60)

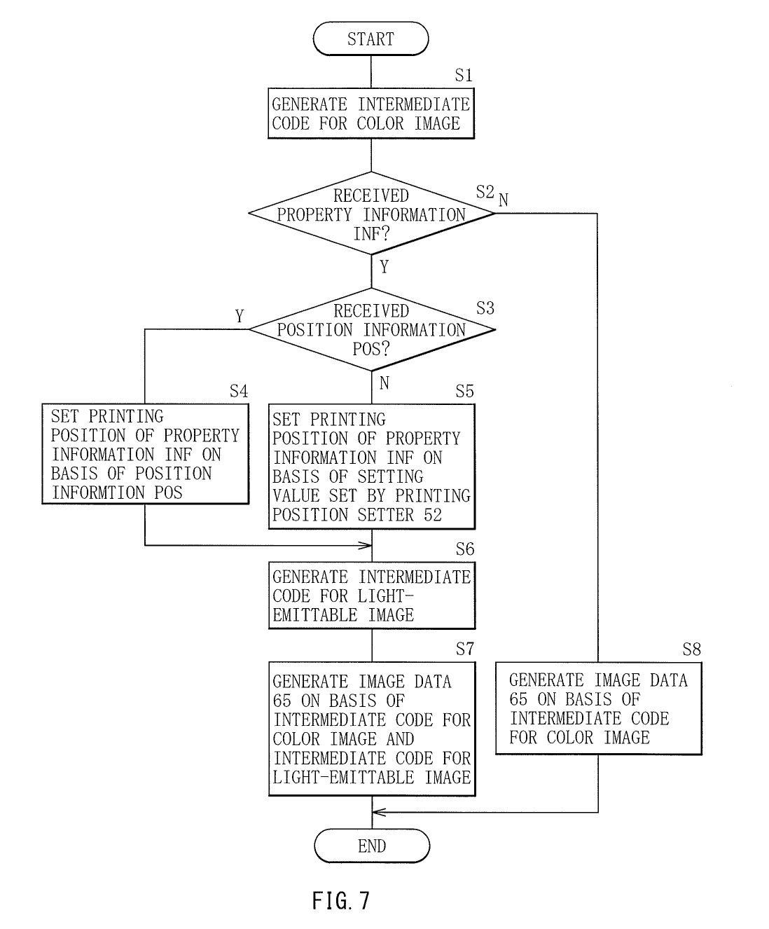

FIG. 7 illustrates an operation example of the image data generator 60. The image data generator 60 may generate the intermediate code for the color image on the basis of the print data DP, and also generate the intermediate code for the light-emittable image on the basis of the property information INF. Further, the image data generator 60 may generate the image data 65 on the basis of the generated intermediate codes. This operation is described below in detail.

First, the print data analyzer 61 in the image data generator 60 generates the intermediate code for the color image on the basis of the print data DP (step S1). Further, the print data analyzer 61 stores the generated intermediate code for the color image in the memory unit 63 as the display list 64.

Thereafter, the tag processor 62 in the print data analyzer 61 confirms whether the communication unit 51 has received the property information INF (step S2). More specifically, the tag processor 62 utilizes the tag TAG to confirm whether the communication unit 51 has received the property information INF.

When the tag processor 62 confirms reception of the property information INF in step S2 (“Y” in step S2), the tag processor 62 confirms whether the communication unit 51 has received the position information POS (step S3). More specifically, the tag processor 62 utilizes the tag TAG to confirm whether the communication unit 51 has received the position information POS. When the tag processor 62 confirms reception of the position information POS (“Y” in step S3), the tag processor 62 sets the printing position of the property information INF on the basis of the received position information POS (step S4). Alternatively, when the tag processor 62 confirms non-reception of the position information POS (“N” in step S3), the tag processor 62 sets the printing position of the property information INF on the basis of the setting value set by the printing position setter 52 (step S5).

Thereafter, the print data analyzer 61 generates the intermediate code for the light-emittable image on the basis of the property information INF and the printing position of the property information INF that has been set in step S4 or step S5 (step S6). Further, the print data analyzer 61 stores the generated intermediate code for the light-emittable image in the memory unit 63 as the display list 64.

Thereafter, the image drawing unit 66 generates the image data 65 on the basis of the intermediate code for the color image and the intermediate code for the light-emittable image (step S7). More specifically, the color image drawing unit 67 in the image drawing unit 66 generates the image data 65K, the image data 65Y, the image data 65M, and the image data 65C on the basis of the intermediate code for the color image. Further, the light-emittable image drawing unit 68 in the image drawing unit 66 generates the image data 65U on the basis of the intermediate code for the light-emittable image. Further, the image drawing unit 66 stores the image data 65K, the image data 65Y, the image data 65M, the image data 65C, and the image data 65U that have been thus generated, in the memory unit 63 as the image data 65.

When the tag processor 62 confirms non-reception of the property information INF in step S2 (“N” in step S2), the image drawing unit 66 generates the image data 65 on the basis of the intermediate code for the color image (step S8). More specifically, the color image drawing unit 67 generates the image data 65K, the image data 65Y, the image data 65M, and the image data 65C on the basis of the intermediate code for the color image. Further, the image drawing unit 66 stores the image data 65K, the image data 65Y, the image data 65M, and the image data 65C that have been thus generated, in the memory unit 63 as the image data 65.

The flow is thus ended.

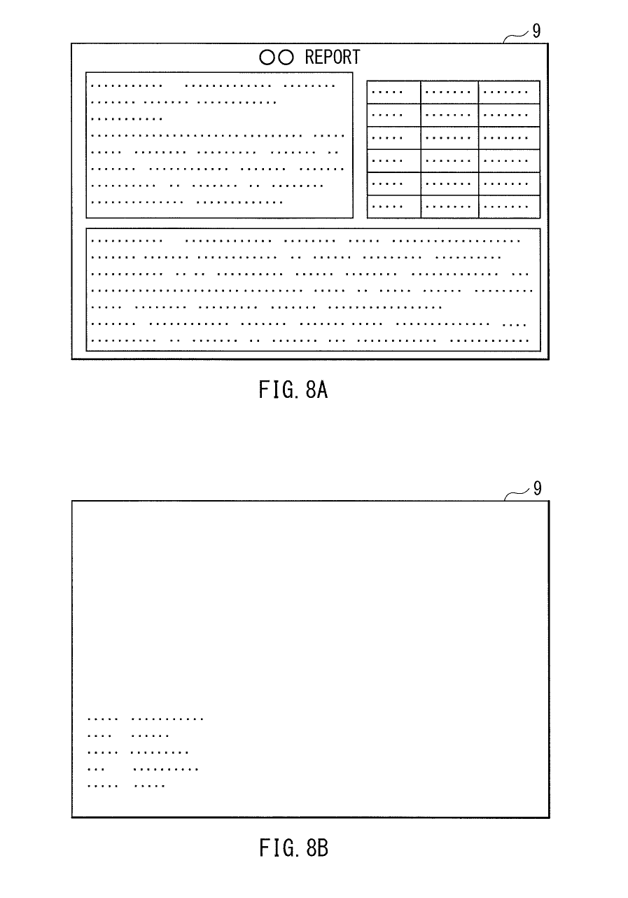

FIG. 8A illustrates an example of the color image that is to be printed with the toner of four colors, i.e., the black toner, the yellow toner, the magenta toner, and the cyan toner. FIG. 8B illustrates an example of the light-emittable image that is to be printed with the light-emittable toner. The image forming apparatus 1 may so print the color image illustrated in FIG. 8A and the light-emittable image illustrated in FIG. 8B that the color image illustrated in FIG. 8A and the light-emittable image illustrated in FIG. 8B overlap each other. More specifically, the property information INF may be printed as the light-emittable image on the lower-left of the recording medium 9 in this example.

The image forming apparatus 1 may print the contents created by the user as the color image, and also print the property information INF as the light-emittable image as described above. This improves usability for the user. More specifically, for example, when the contents and the property information INF are both printed as the color images, the contents and the property information INF may overlap each other. This may degrade visibility. Alternatively, for example, when the property information INF is printed as the color image in a margin of the contents, for example, visibility may be degraded due to a narrow margin. More specifically, such a case may require reduction in size of the property information INF or change of a layout of the property information INF to print the property information INF. This may lead to degradation in visibility. In contrast, the image forming apparatus 1 may print the contents as the color image and print the property information INF as the light-emittable image. This causes the property information printed with predetermined size at the predetermined position on the recording medium 9 to be visible to the user as the light-emittable image, due to the user's application of ultraviolet rays using ultraviolet light, for example. Accordingly, the image forming apparatus 1 makes it possible to improve visibility when the user sees the property information, leading to an improvement in usability for the user. Further, for example, in absence of the user's application of the ultraviolet rays, the property information may be transparent, which makes it difficult for the user to see the property information. Thus, the image forming apparatus 1 makes it possible to improve visibility for the user when the user sees the contents, leading to an improvement in usability for the user.

Further, the image forming apparatus 1 may so print the property information INF of the contents that the property information INF of the contents and the contents overlap each other, when the contents are printed on the entire surface of the recording medium 9. This improves usability for the user. More specifically, the user may want to confirm the property information INF such as the name of the creator of the printed contents and the date and the time of creation of the printed contents in many cases. In such a case, it may be troublesome for the user to confirm the property information INF by referring to an electronic file of the contents, if the property information INF is not printed. Further, for example, when the property information INF is printed on a back surface of the recording medium 9 on which the contents are printed, a usable region of the recording medium 9 may be limited thereby. More specifically, such a case may not allow for printing contents on both surfaces of the recording medium 9, or attaching the recording medium 9 to another medium. In contrast, the image forming apparatus 1 may so print the property information INF of the contents that the property information INF is overlaid on the contents. This allows the user to immediately confirm the property information INF of the contents by applying the ultraviolet rays using the ultraviolet light. As a result, the image forming apparatus 1 makes it possible to improve usability for the user.

### [Effects]

According to the present example embodiment, the contents are printed as the color image, and the property information is printed as the light-emittable image, as described above. This improves usability for the user.

Further, according to the present example embodiment, the property information is so printed as to be overlaid on the contents. This also improves usability for the user.

Moreover, according to one example embodiment, the light-emittable image is caused to be overlaid on part or all of the color image. This also improves usability for the user.

Moreover, according to one example embodiment, the data of the color image is generated on the basis of the print data, and the data of the light-emittable image is generated on the basis of the property information. This also improves usability.

### [Modification 1-1]

The property information INF is printed as the light-emittable image in the foregoing example embodiment. However, this is not limitative. The information to be printed as the light-emittable image may be any information that is related to the contents to be printed as the color image, for example. Preferably, such information may be information that is confirmed by the user only on an as-needed basis, for example.

### 2. Second Example Embodiment

Next, an image forming apparatus 2 according to a second example embodiment is described. The present example embodiment may have a configuration in which a printing position of a light-emittable object is variable depending on the color image. It is to be noted that the component parts that are substantially the same as those in the image forming apparatus 1 according to the foregoing first example embodiment are denoted with the same numerals, and are not described further where appropriate.

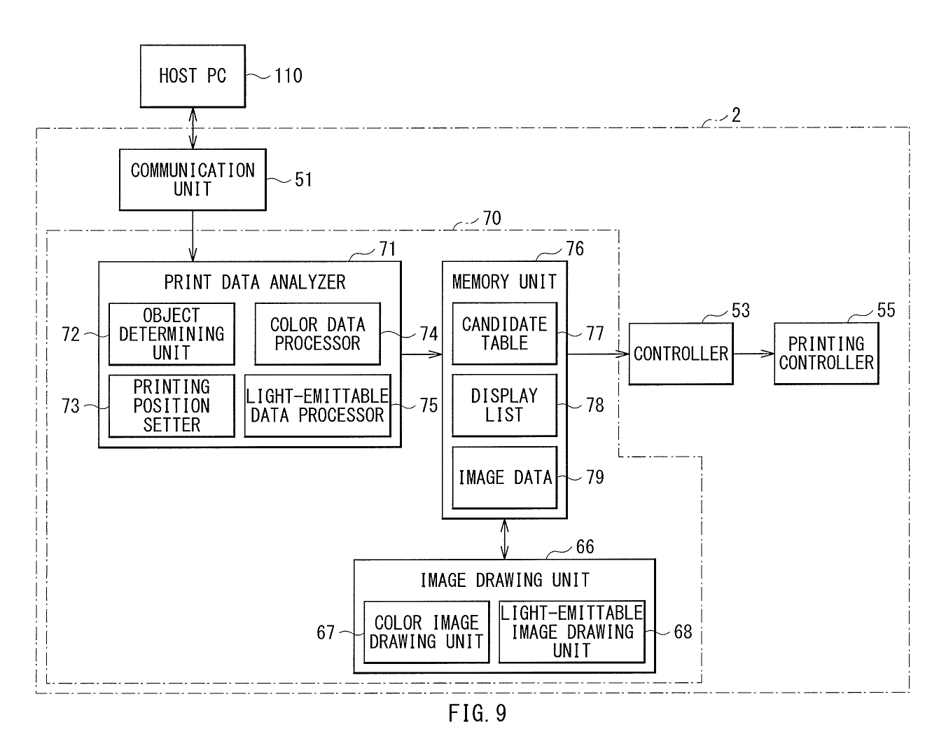

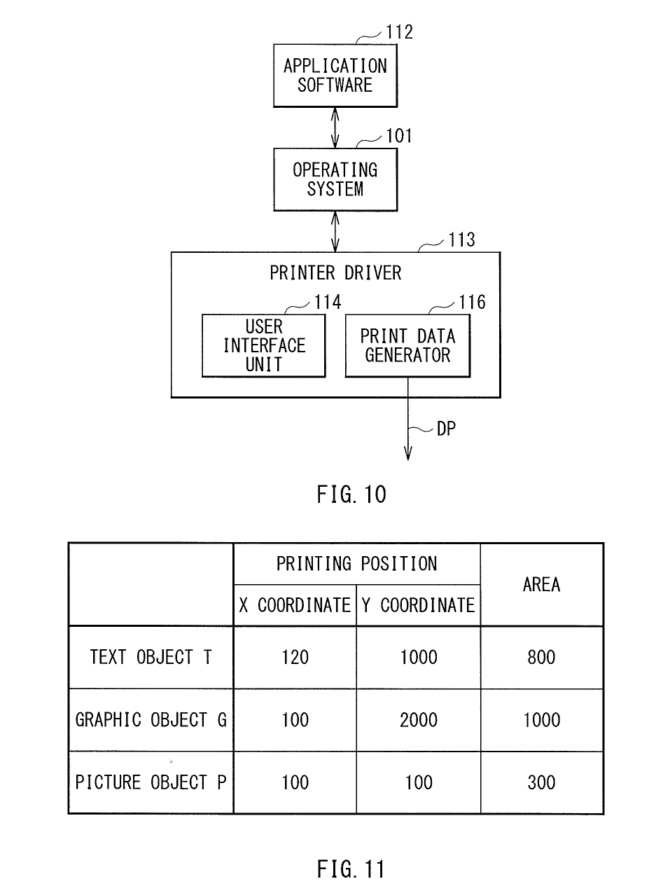

FIG. 9 illustrates an example of a control mechanism in the image forming apparatus 2. FIG. 10 illustrates an example of a software configuration in a host PC 110 that supplies the print data to the image forming apparatus 2. Application software 112 and a printer driver 113 may be installed on the host PC 110.

The application software 112 may be software such as word processor software and spreadsheet software, for example. The application software 112 may also generate the contents data for the light-emittable image that is to be printed with the light-emittable toner, in addition to the contents data for the color image that is to be printed with the toner of four colors, i.e., the black toner, the yellow toner, the magenta toner, and the cyan toner. The color image may include one or more of the picture object P, the graphic object G, and the text object T. Further, the light-emittable image may include a light-emittable object U.

The printer driver 113 may include a user interface unit 114 and a print data generator 116. The user interface unit 114 may display the printing setting screen on a display unit of the host PC 110. The user interface unit 114 may also perform various types of printing setting in response to reception of the instructions from the user. The print data generator 116 may generate the print data DP, and transmit the generated print data DP to the image forming apparatus 2. Upon transmitting the print data DP, the print data generator 116 may generate printing job data including type information that indicates a type of the respective objects and position information that indicates the printing positions of the respective objects. Further, the print data generator 116 may generate the print data DP on the basis of the spooled file and the printing job data.

The image forming apparatus 2 illustrated in FIG. 9 may include an image data generator 70. The image data generator 70 may include a print data analyzer 71, the image drawing unit 66, and a memory unit 76.

The print data analyzer 71 may analyze the print data DP to thereby generate the intermediate code for the color image that is to be printed with the toner of four colors, i.e., the black toner, the yellow toner, the magenta toner, and the cyan toner, and also generate the intermediate code for the light-emittable image that is to be printed with the light-emittable toner. The print data analyzer 71 may include an object determining unit 72, a printing position setter 73, a color data processor 74, and a light-emittable data processor 75.

The object determining unit 72 may determine the types of the respective objects on the basis of the printing job data included in the print data DP. The object determining unit 72 may also acquire the printing positions of the respective objects. Further, the object determining unit 72 may also generate a candidate table 77 described below, on the basis of the respective objects and the printing job data included in the print data DP.

FIG. 11 illustrates an example of the candidate table 77. In this example, the candidate table 77 includes information about a printing position and the area of an object having the largest area out of a plurality of text objects T, information about a printing position and the area of an object having the largest area out of a plurality of graphic objects G, and information about a printing position and the area of an object having the largest area out of a plurality of picture objects P.

The object determining unit 72 may generate the candidate table 77 as described above on the basis of the print data DP. Further, the object determining unit 72 may store the generated candidate table 77 in the memory unit 76.

The printing position setter 73 may set a printing position of the light-emittable object U on the basis of the candidate table 77 stored in the memory unit 76.

The color data processor 74 may generate an intermediate code for each of the picture object P, the graphic object G, and the text object T for the color image, on the basis of the print data DP. Further, for example, for the graphic object G, the color data processor 74 may generate attribute information including information related to a width of a line forming the graphic, etc., for example. Further, for example, for the text object T, the color data processor 74 may generate attribute information including information related to font size of the text, etc., for example. Further, the color data processor 74 may store the intermediate codes, the position information, the type information, and the attribute information in the memory unit 76 as a display list 78.

The light-emittable data processor 75 may locate the light-emittable object U at the printing position set by the printing position setter 73, on the basis of the print data DP, to thereby generate the intermediate code. Further, the light-emittable data processor 75 may store the generated intermediate code in the memory unit 76 as the display list 78.

The image drawing unit 66 may generate image data 79K, image data 79Y, image data 79M, image data 79C, and image data 79U on the basis of the display list 78 stored in the memory unit 76, as in the foregoing first example embodiment. Further, the image drawing unit 66 may store the image data 79K, the image data 79Y, the image data 79M, the image data 79C, and the image data 79U that have been thus generated, in the memory unit 76 as image data 79.

The memory unit 76 may store the candidate table 77, the display list 78, and the image data 79.

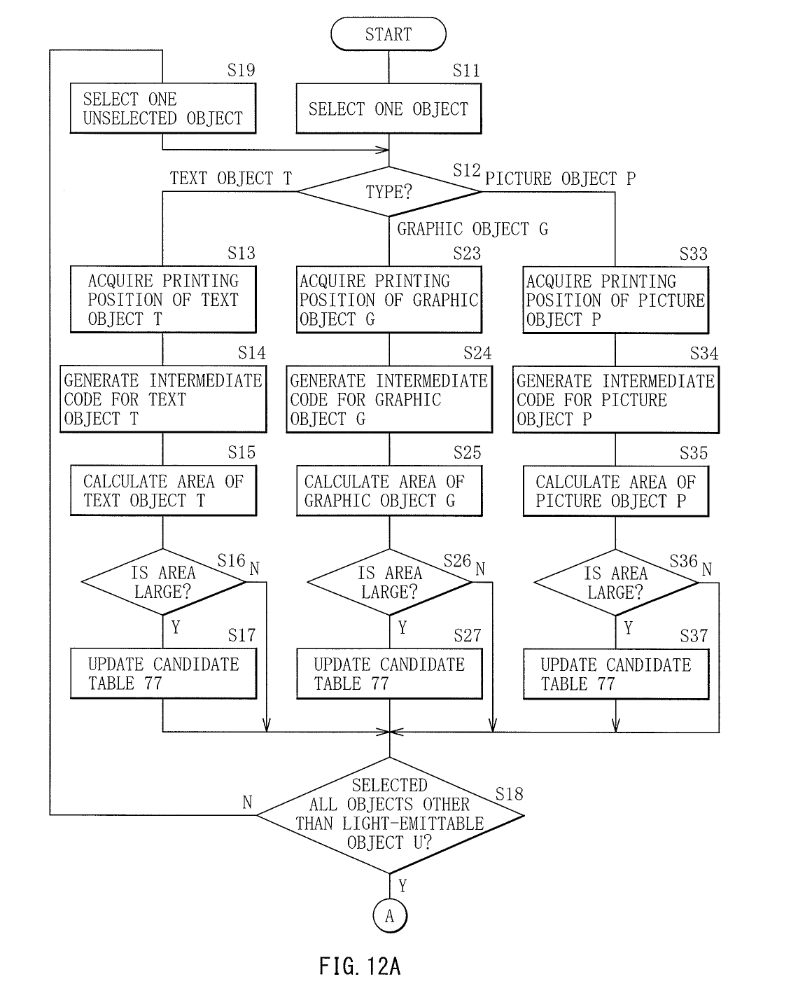

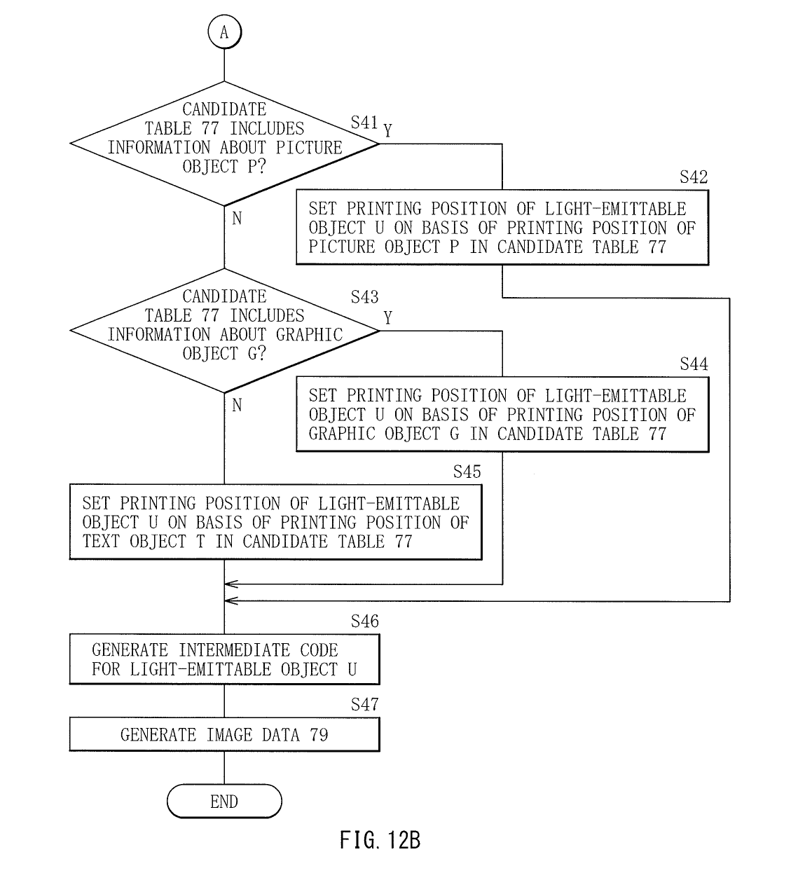

FIGS. 12A and 12B illustrate an operation example of the image data generator 70. The image data generator 70 may generate the intermediate code for the color image on the basis of the print data DP. The image data generator 70 may also generate the candidate table 77, and generate the intermediate code for the light-emittable image on the basis of the print data DP and the generated candidate table 77. Further, the image data generator 70 may generate the image data 79 on the basis of the generated intermediate codes. This operation is described below in detail.

First, the object determining unit 72 in the image data generator 70 selects one of the plurality of objects other than the light-emittable object U, on the basis of the print data DP (step S11).

Next, the object determining unit 72 confirms the type of the selected object on the basis of the printing job data in the print data DP (step S12).

When the selected object is determined to be the text object T in step S12, first, the object determining unit 72 acquires the printing position of the selected text object T on the basis of the printing job data (step S13). Further, the color data processor 74 generates the intermediate code for the selected text object T (step S14). Upon generating the intermediate code, the color data processor 74 generates the attribute information including the information related to the font size of the text, etc. Further, the color data processor 74 stores the generated intermediate code, the position information, the type information, and the attribute information in the memory unit 76 as the display list 78. Thereafter, the object determining unit 72 calculates the area of the selected text object T (step S15). Further, the object determining unit 72 confirms whether the area calculated in step S15 is larger than the area of the text object T in the candidate table 77 (step S16). When the area calculated in step S15 is determined to be larger than the area of the text object T in the candidate table 77 (“Y” in step S16), the object determining unit 72 may update the candidate table 77 using the printing position of the text object T acquired in step S13 and the area of the text object T calculated in step S15 (step S17). Further, the process proceeds to step S18.

When the selected object is determined to be the graphic object Gin step S12, first, the object determining unit 72 acquires the printing position of the selected graphic object G on the basis of the printing job data (step S23). Further, the color data processor 74 generates the intermediate code for the selected graphic object G (step S24). Upon generating the intermediate code, the color data processor 74 generates the attribute information including the information related to the width of the line forming the graphic, etc. Further, the color data processor 74 stores the generated intermediate code, the position information, the type information, and the attribute information in the memory unit 76 as the display list 78. Thereafter, the object determining unit 72 calculates the area of the selected graphic object G (step S25). Further, the object determining unit 72 confirms whether the area calculated in step S25 is larger than the area of the graphic object G in the candidate table 77 (step S26). When the area calculated in step S25 is determined to be larger than the area of the graphic object G in the candidate table 77 (“Y” in step S26), the object determining unit 72 updates the candidate table 77 using the printing position of the graphic object G acquired in step S23 and the area of the graphic object G calculated in step S25 (step S27). Further, the process proceeds to step S18.

When the selected object is determined to be the picture object P in step S12, first, the object determining unit 72 acquires the printing position of the selected picture object P on the basis of the printing job data (step S33). Further, the color data processor 74 generates the intermediate code for the selected picture object P (step S34). Further, the color data processor 74 stores the generated intermediate code, the position information, and the type information in the memory unit 76 as the display list 78. Thereafter, the object determining unit 72 calculates the area of the selected picture object P (step S35). Further, the object determining unit 72 confirms whether the area calculated in step S35 is larger than the area of the picture object P in the candidate table 77 (step S36). When the area calculated in step S35 is determined to be larger than the area of the picture object P in the candidate table 77 (“Y” in step S36), the object determining unit 72 updates the candidate table 77 using the printing position of the picture object P acquired in step S33 and the area of the picture object P calculated in step S35 (step S37). Further, the process proceeds to step S18.

Thereafter, the object determining unit 72 confirms whether the object determining unit 72 has selected all of the objects other than the light-emittable object U (step S18). When the object determining unit 72 has not selected all of the objects other than the light-emittable object U (“N” in step S18), the object determining unit 72 selects one of the unselected objects other than the light-emittable object U (step S19), and the process proceeds to step S12. The foregoing processing is repeated until all of the objects other than the light-emittable object U are selected.

When the object determining unit 72 has confirmed that the object determining unit 72 has selected all of the objects other than the light-emittable object U (“Y” in step S18), next, the printing position setter 73 in the print data analyzer 71 confirms whether the candidate table 77 includes information about the picture object P (step S41). When the printing position setter 73 has confirmed that the candidate table 77 includes the information about the picture object P (“Y” in step S41), the printing position setter 73 sets the printing position of the light-emittable object U on the basis of the printing position of the picture object P in the candidate table 77 (step S42), and the procedure proceeds to step S46.

When the printing position setter 73 has confirmed that the candidate table 77 does not include the information about the picture object P in step S41 (“N” in step S41), the printing position setter 73 confirms whether the candidate table 77 includes information about the graphic object G (step S43). When the printing position setter 73 has confirmed that the candidate table 77 includes the information about the graphic object G (“Y” in step S43), the printing position setter 73 sets the printing position of the light-emittable object U on the basis of the printing position of the graphic object G in the candidate table 77 (step S44), and the procedure proceeds to step S46.

When the printing position setter 73 has confirmed that the candidate table 77 does not include information about the graphic object G (“N” in step S43), the printing position setter 73 sets the printing position of the light-emittable object U on the basis of the printing position of the text object T in the candidate table 77 (step S45).

Thereafter, the light-emittable data processor 75 generates the intermediate code for the light-emittable object U on the basis of the print data DP (step S46). More specifically, the light-emittable data processor 75 generates the intermediate code on the basis of the light-emittable object U and the printing position that has been set in step S42, S44, or S45. Further, the light-emittable data processor 75 stores the generated intermediate code in the memory unit 76 as the display list 78.

Thereafter, the image drawing unit 66 generates the image data 79 on the basis of the intermediate code for the color image and the intermediate code for the light-emittable image (step S47). More specifically, the color image drawing unit 67 in the image drawing unit 66 generates the image data 79K, the image data 79Y, the image data 79M, and the image data 79C on the basis of the intermediate codes for the picture object P, the graphic object G, and the text object T, the position information, the type information, and the attribute information. Further, the light-emittable image drawing unit 68 generates the image data 79U on the basis of the intermediate code for the light-emittable object U. Further, the image drawing unit 66 stores the image data 79K, the image data 79Y, the image data 79M, the image data 79C, and the image data 79U that have been thus generated, in the memory unit 76 as the image data 79.

The flow is thus ended.

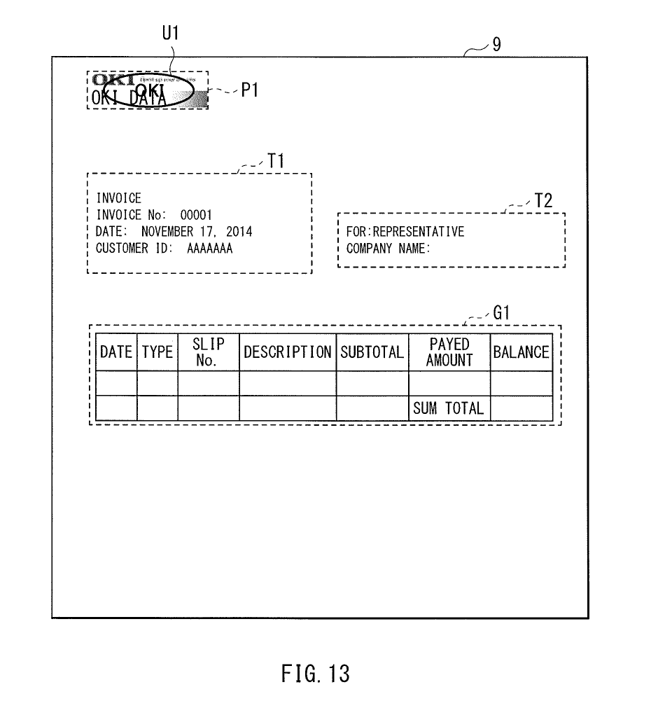

FIG. 13 illustrates an example image printed on the recording medium 9. In this example, one picture object P1, one graphic object G1, and two text objects T1 and T2 are printed on the recording medium 9 as the color image, and a light-emittable object U1 is printed on the recording medium 9 as the light-emittable image. The light-emittable object U1 is so printed as to be overlaid on the picture object P1. In other words, referring to FIG. 12B, the printing position setter 73 confirms that the candidate table 77 includes the information about the picture object P1 (step S41) in this example. The printing position setter 73 therefore sets the printing position of the light-emittable object U1 on the basis of the printing position of the picture object P1 (step S42).

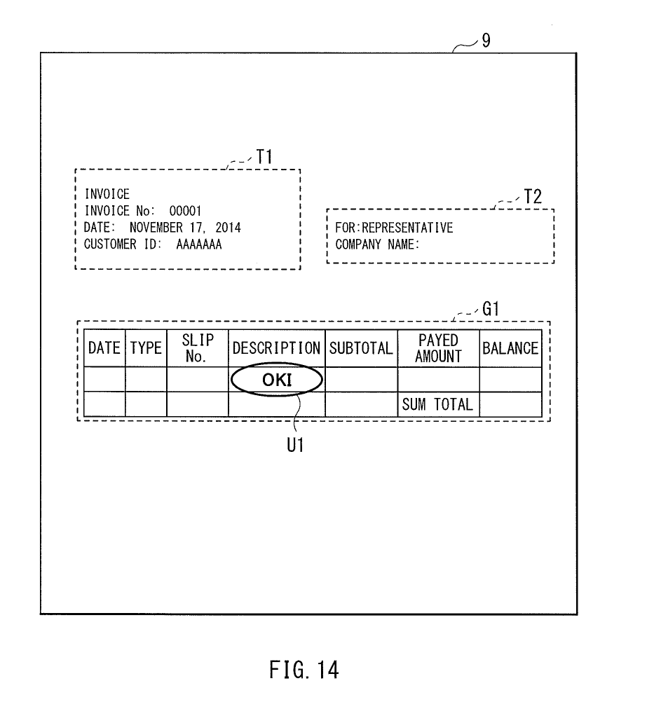

FIG. 14 illustrates another example image printed on the recording medium 9. In this example, one graphic object G1 and two text objects T1 and T2 are printed on the recording medium 9 as the color image, and a light-emittable object U1 is printed on the recording medium 9 as the light-emittable image. The light-emittable object U1 is so printed as to be overlaid on the graphic object G1. In other words, referring to FIG. 12B, the printing position setter 73 confirms that the candidate table 77 does not include the information about the picture object P (step S41) but includes the information about the graphic object G1 (step S43) in this example. The printing position setter 73 therefore sets the printing position of the light-emittable object U1 on the basis of the printing position of the graphic object G1 (step S44).

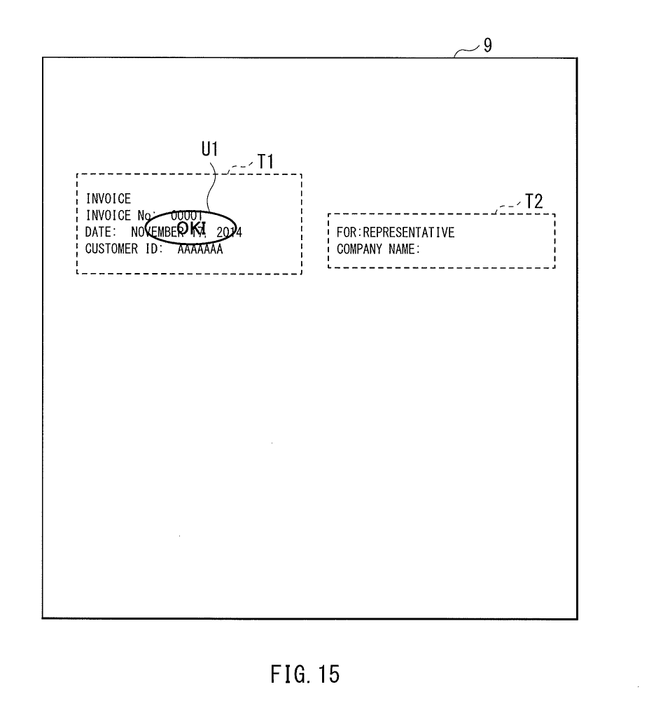

FIG. 15 illustrates yet another example image printed on the recording medium 9. In this example, two text objects T1 and T2 are printed on the recording medium 9 as the color image, and a light-emittable object U1 is printed on the recording medium 9 as the light-emittable image. The light-emittable object U1 is so printed as to be overlaid on one of the two text objects T1 and T2 that has the larger area. In other words, referring to FIG. 12B, the printing position setter 73 confirms that the candidate table 77 does not include the information about the picture object P (step S41), and does not include the information about the graphic object G (step S43) in this example. The printing position setter 73 therefore sets the printing position of the light-emittable object U1 on the basis of the printing position of the text object T1 having the larger area (step S45).

The image forming apparatus 2 may change the printing position of the light-emittable object depending on the color image as described above. This improves usability for the user. More specifically, for example, the light-emittable object U may be seen by the user due to a difference in gloss level even when the user does not apply ultraviolet rays on the light-emittable object U. Accordingly, for example, when the light-emittable object is located in a margin of the color image, the light-emittable object U may be visible in the margin, degrading visual quality. In contrast, the image forming apparatus 2 may change the printing position of the light-emittable object U depending on the color image. More specifically, the image forming apparatus 2 may so print the light-emittable object U that the light-emittable object U is overlaid on the object included in the color image. This makes it difficult for the light-emittable object U to be seen, improving the visual quality. As a result, it is possible to improve usability for the user.

Moreover, the image forming apparatus 2 may so print the light-emittable object U that the light-emittable object U is overlaid on the picture object P when the color image includes the picture object P. This improves usability for the user. More specifically, the picture object P usually includes less blank part than the graphic object G and the test object T. Hence, it is more difficult for the light-emittable object U to be seen when the light-emittable object U is so printed as to be overlaid on the picture object P than when the light-emittable object U is so printed as to be overlaid on the graphic object G or the text object T. As a result, the image forming apparatus 2 makes it possible to improve visual quality, leading to an improvement in usability for the user.

Moreover, for example, when the color image includes a plurality of picture objects P, the image forming apparatus 2 may print the light-emittable object U so that the light-emittable object U is overlaid on the picture object P having the largest area in the plurality of picture objects P. This improves usability for the user. More specifically, it is more difficult for the light-emittable object U to be seen when the light-emittable object U is so printed as to be overlaid on the larger picture object P than when the light-emittable object U is so printed as to be overlaid on the smaller picture object P. As a result, the image forming apparatus 2 makes it possible to improve visual quality, leading to an improvement in usability for the user.

According to the present example embodiment, the printing position of the light-emittable object is changed depending on the color image as described above. Accordingly, it is possible to improve usability for the user.

Moreover, according to the present example embodiment, the light-emittable object is so printed as to be overlaid on the picture object when the color image includes the picture object. Accordingly, it is possible to improve usability for the user.

Moreover, according to the present example embodiment, the light-emittable object is so printed as to be overlaid on the picture object having the largest picture object in a plurality of picture objects, when the color image includes the plurality of picture objects. Accordingly, it is possible to improve usability for the user.

Other effects of the present example embodiment may be similar to those of the foregoing first example embodiment.

### [Modification 2-1]

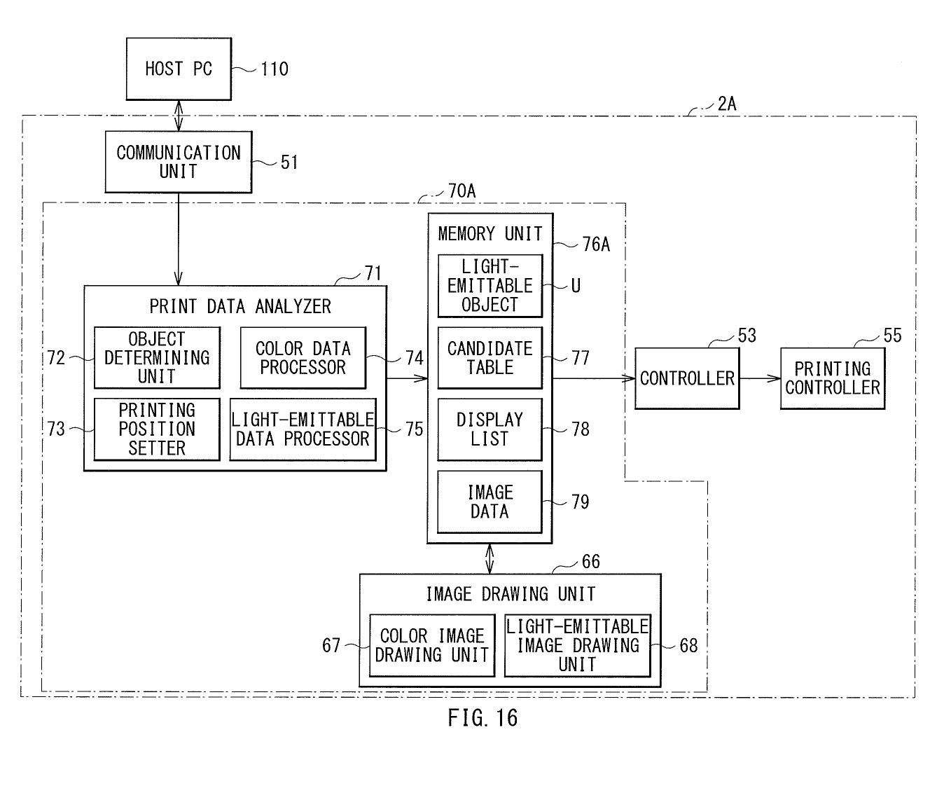

According to the foregoing example embodiment, the application software 102 generates the contents data including the light-emittable object U. However, this is not limitative. Alternatively, for example, the user may select the light-emittable object U that has been created in advance, using the printing setting screen of the printer driver 113. Alternatively, for example, the light-emittable object U that has been created in advance may be stored in an image forming apparatus 2A as illustrated in FIG. 16. The image forming apparatus 2A may include an image data generator 70A. The image data generator 70A may include a memory unit 76A. The memory unit 76A may store the light-emittable object U. This configuration may cause the light-emittable data processor 75 in the print data analyzer 71 to locate the light-emittable object U stored in the memory unit 76A at the printing position set by the printing position setter 73, to thereby generate the intermediate code.

### [Modification 2-2]

According to the foregoing example embodiment, the light-emittable object U is so printed as to be overlaid on the picture object P, for example. Upon so printing the light-emittable object U that the light-emittable object U is overlaid on the picture object P, the size of the light-emittable object U may be adjusted depending on the size of the picture object P. More specifically, the candidate table 77 may include information about the width and the height of the object in addition to the information about the printing position and the area of the object. Further, the printing position setter 73 may determine a scale-up rate or a scale-down rate of the light-emittable object U depending on the candidate table 77 and the size of the light-emittable object U, upon setting the printing position of the light-emittable object U.

### [Modification 2-3]

According to the foregoing example embodiment, the candidate table 77 includes the information about the printing position and the area of the object having the largest area in the plurality of text objects T, the information about the printing position and the area of the object having the largest area in the plurality of graphic objects G, and the information about the printing position and the area of the object having the largest area in the plurality of picture objects P. However, this is not limitative. Alternatively, conditions for the information to be recorded in the candidate table 77 may be changed depending on the types of the objects. More specifically, for example, the information about the printing position and the area of the object having the largest area in the plurality of objects may be recorded for the picture objects P and the graphic objects G, and the information about the printing position and the area of the object having the smallest area in the plurality of objects may be recorded for the text objects T. More specifically, the foregoing configuration may be adopted, for example, in a case where the light-emittable object U is more difficult to be seen on the picture object P having the larger area when the light-emittable object U is so printed as to be overlaid on the picture object P, and the light-emittable object U is more difficult to be seen on the text object T having the smaller area when the light-emittable object U is so printed as to be overlaid on the text object T.

The invention has been described above referring to some example embodiments and the modifications thereof. However, the invention is not limited to the foregoing example embodiments and the modifications thereof, and may be variously modified.

The foregoing example embodiments each refer to the example case where the invention is applied to a printer. However, this is not limitative. The invention may be applied to a so-called multi-function peripheral apparatus having functions of a copier, a facsimile, a scanner, etc., for example.

Moreover, the foregoing example embodiments each refer to the example case where the invention is applied to a color printer. However, this is not limitative. The invention may be applied to a monochrome printer that performs printing using the black toner and the light-emittable toner, for example.

Moreover, the foregoing example embodiments each refer to the example case where the invention is applied to a printer that forms an image by an electrophotographic method. However, this is not limitative. The invention may be applied to any other kind of printer such as an inkjet printer, for example.

Furthermore, the invention encompasses any possible combination of some or all of the various embodiments and the modifications described herein and incorporated herein.

It is possible to achieve at least the following configurations from the above-described example embodiments of the invention.

(1)

An image forming apparatus, including:

a first image forming unit that forms a first image on a basis of first image data;

a second image forming unit that forms a light-emittable second image on a basis of second image data; and

a generator that generates the first image data on a basis of print data, and generates the second image data to cause the second image to be overlaid on part or all of the first image.

(2)

The image forming apparatus according to (1), wherein the generator generates the second image data to cause the second image to be located at a predetermined position on a recording medium.

(3)

The image forming apparatus according to (2), wherein

the print data is generated on a basis of data information, and

the generator generates the second image data on a basis of additional information of the data information, the additional information accompanying the print data.

(4)

The image forming apparatus according to (3), wherein

the additional information includes a plurality of pieces of additional information,

the print data is accompanied by a plurality of tags in addition to the plurality of pieces of additional information, the plurality of tags corresponding to the respective pieces of additional information, and

the generator generates the second image data on a basis of the plurality of pieces of additional information and the tags.

(5)

The image forming apparatus according to (4), wherein

the print data is accompanied by a plurality of pieces of position information that indicate respective positions at which the respective plurality of pieces of additional information are to be located, and

the generator generates the second image also on a basis of the plurality of pieces of position information in addition to the plurality of pieces of additional information and the tags.

(6)

The image forming apparatus according to any one of (2) to (4), further including a position setter that sets the predetermined position.

(7)

The image forming apparatus according to (1), wherein the generator determines a location position of the second image on a basis of one or a plurality of location positions of respective one or a plurality of partial images to generate the second image data, the one or the plurality of partial images being included in the first image.

(8)

The image forming apparatus according to (7), wherein each of the one or the plurality of partial images belongs to one of a plurality of types including a picture type, a graphic type, and a text type, and the generator determines the location position of the second image on a basis of the location position of each of the one or the plurality of partial images and the type of each of the one or the plurality of partial images.

(9)

The image forming apparatus according to (7) or (8), wherein the generator generates the second image data on a basis of the print data. (10)

The image forming apparatus according to (8), wherein the generator determines the location position of the second image on a basis of a location position of a first partial image, when the one or the plurality of partial images include one or a plurality of partial images that belong to the picture type, the first partial image being included in the one or the plurality of partial images that belong to the picture type.

(11)

The image forming apparatus according to (10), wherein the first partial image is a partial image having largest area in the one or the plurality of partial images (P) that belong to the picture type.

(12)

The image forming apparatus according to any one of (8) to (11), wherein the generator determines the location position of the second image on a basis of a location position of a second partial image, when the one or the plurality of partial images include no partial image that belongs to the picture type, and include one or a plurality of partial images that belong to the graphic type, the second partial image being included in the one or the plurality of partial images that belong to the graphic type.

(13)

The image forming apparatus according to any one of (8) to (12), wherein the generator determines the location position of the second image on a basis of a location position of a third partial image, when the one or the plurality of partial images include no partial image that belongs to the picture type, include no partial image that belongs to the graphic type, and include one or a plurality of partial images that belong to the text type, the third partial image being included in the one or the plurality of partial images that belong to the text type.

(14)

The image forming apparatus according to any one of (1) to (13), wherein the second image forming unit forms the second image using light-emittable toner.

(15)

An image forming apparatus, including:

a first image forming unit that forms a first image on a basis of first image data;

a second image forming unit that forms a light-emittable second image on a basis of second image data; and

a generator that generates the first image data on a basis of print data generated on a basis of data information, and generates the second image data on a basis of additional information of the data information, the additional information accompanying the print data.

(16)

The image forming apparatus according to (15), wherein the generator generates the second image data to cause the second image to be located at a predetermined position on a recording medium.

(17)

An information processing apparatus, including a print data generator that generates print data on a basis of data information, and causes additional information of the data information to accompany the print data.

(18)

The information processing apparatus according to (17), wherein

the additional information includes a plurality of pieces of additional information, and

the print data generator generates a plurality of tags on a basis of the plurality of pieces of additional information, and causes the tags to accompany the print data in addition to the additional information, the plurality of tags corresponding to the respective pieces of additional information.

(19)

The information processing apparatus according to (18), wherein the print data generator generates a plurality of pieces of position information on the basis of the plurality of pieces of additional information, and also causes the plurality of pieces of position information to accompany the print data, the plurality of pieces of position information indicating respective positions at which the respective pieces of additional information are to be located.

(20)

The information processing unit according to any one of (17) to (19), wherein the additional information is to be formed as a light-emittable image on a recording medium.

(21)

The information processing unit according to any one of (17) to (20), wherein the additional information is property information of the data information.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. An image forming apparatus, comprising:
a first image forming unit that forms a first image on a basis of first image data;
a second image forming unit that forms a light-emittable second image on a basis of second image data; and
a generator that generates the first image data on a basis of print data, and generates the second image data to cause the second image to be overlaid on part or all of the first image.

2. The image forming apparatus according to claim 1, wherein the generator generates the second image data to cause the second image to be located at a predetermined position on a recording medium.

3. The image forming apparatus according to claim 2, wherein
the print data is generated on a basis of data information, and
the generator generates the second image data on a basis of additional information of the data information, the additional information accompanying the print data.

4. The image forming apparatus according to claim 3, wherein
the additional information includes a plurality of pieces of additional information,
the print data is accompanied by a plurality of tags in addition to the plurality of pieces of additional information, the plurality of tags corresponding to the respective pieces of additional information, and
the generator generates the second image data on a basis of the plurality of pieces of additional information and the tags.

5. The image forming apparatus according to claim 4, wherein
the print data is accompanied by a plurality of pieces of position information that indicate respective positions at which the respective plurality of pieces of additional information are to be located, and
the generator generates the second image also on a basis of the plurality of pieces of position information in addition to the plurality of pieces of additional information and the tags.

6. The image forming apparatus according to claim 2, further comprising a position setter that sets the predetermined position.

7. The image forming apparatus according to claim 1, wherein the generator determines a location position of the second image on a basis of one or a plurality of location positions of respective one or a plurality of partial images to generate the second image data, the one or the plurality of partial images being included in the first image.

8. The image forming apparatus according to claim 7, wherein
each of the one or the plurality of partial images belongs to one of a plurality of types including a picture type, a graphic type, and a text type, and
the generator determines the location position of the second image on a basis of the location position of each of the one or the plurality of partial images and the type of each of the one or the plurality of partial images.

9. The image forming apparatus according to claim 7, wherein the generator generates the second image data on a basis of the print data.

10. The image forming apparatus according to claim 8, wherein the generator determines the location position of the second image on a basis of a location position of a first partial image, when the one or the plurality of partial images include one or a plurality of partial images that belong to the picture type, the first partial image being included in the one or the plurality of partial images that belong to the picture type.

11. The image forming apparatus according to claim 10, wherein the first partial image is a partial image having largest area in the one or the plurality of partial images that belong to the picture type.

12. The image forming apparatus according to claim 8, wherein the generator determines the location position of the second image on a basis of a location position of a second partial image, when the one or the plurality of partial images include no partial image that belongs to the picture type, and include one or a plurality of partial images that belong to the graphic type, the second partial image being included in the one or the plurality of partial images that belong to the graphic type.

13. The image forming apparatus according to claim 8, wherein the generator determines the location position of the second image on a basis of a location position of a third partial image, when the one or the plurality of partial images include no partial image that belongs to the picture type, include no partial image that belongs to the graphic type, and include one or a plurality of partial images that belong to the text type, the third partial image being included in the one or the plurality of partial images that belong to the text type.

14. The image forming apparatus according to claim 1, wherein the second image forming unit forms the second image using light-emittable toner.

15. An image forming apparatus, comprising:
a first image forming unit that forms a first image on a basis of first image data;
a second image forming unit that forms a light-emittable second image on a basis of second image data; and
a generator that generates the first image data on a basis of print data generated on a basis of data information, and generates the second image data on a basis of additional information of the data information, the additional information accompanying the print data.

16. The image forming apparatus according to claim 15, wherein the generator generates the second image data to cause the second image to be located at a predetermined position on a recording medium.

17. An information processing apparatus, comprising a print data generator that generates print data on a basis of data information, and causes additional information of the data information to accompany the print data.

18. The information processing apparatus according to claim 17, wherein
the additional information includes a plurality of pieces of additional information, and
the print data generator generates a plurality of tags on a basis of the plurality of pieces of additional information, and causes the tags to accompany the print data in addition to the additional information, the plurality of tags corresponding to the respective pieces of additional information.

19. The information processing apparatus according to claim 18, wherein the print data generator generates a plurality of pieces of position information on the basis of the plurality of pieces of additional information, and also causes the plurality of pieces of position information to accompany the print data, the plurality of pieces of position information indicating respective positions at which the respective pieces of additional information are to be located.

20. The information processing unit according to claim 17, wherein the additional information is to be formed as a light-emittable image on a recording medium.
